(19) United States
(12) Patent Application Publication
(10) Pub. No.: US 2013/0209638 A1
(43) Pub. Date: Aug. 15, 2013

(54) FLUIDIZED BED COFFEE ROASTER HAVING DUAL-STAGE QUENCHING CYCLE

(71) Applicants: Richard C. Sewell, West Bloomfield, MI (US); James N. Suddath, West Bloomfield, MI (US)

(72) Inventors: Richard C. Sewell, West Bloomfield, MI (US); James N. Suddath, West Bloomfield, MI (US)

(73) Assignee: Gourmet Coffee Roasters Inc., Wixom, MI (US)

(21) Appl. No.: 13/370,792

(22) Filed: Feb. 10, 2012

(51) Int. Cl. A23N 12/08; F26B 21/06; F26B 21/12; A23F 5/04

(52) U.S. Cl. 426/466; 34/553; 34/543

(57) ABSTRACT

A fluidized bed coffee roaster provides a two stage quenching cycle for rapidly cooling roasted coffee beans to ambient temperature. In a first stage of the quenching cycle unheated air is passed through the roasted beans while they are still in the roasting chamber of the fluidized bed roaster. In a second stage of the quenching cycle which is carried out outside of the roasting chamber, in a fluidized bed quenching station, unheated air is flowed through, and fluidizes, the roasted coffee beans cooling the to ambient temperature.

### CROSS-REFERENCE TO RELATED APPLICATIONS

Not applicable.

### FIELD OF THE INVENTION

This invention relates to devices for roasting coffee, nuts, grains and other such materials. More specifically, the invention relates to a fluidized bed coffee roaster in which the coffee beans being roasted are at least partially suspended in a stream of heated air. Most specifically, the invention relates to a self-contained, coffee roasting apparatus in which the heated, roasted beans are cooled to an ambient temperature in a two stage quenching cycle

### BACKGROUND OF THE INVENTION

Coffee is a beverage with global and growing appeal, and there is an ever-increasing demand for high quality coffee. Coffee beans must be roasted prior to brewing. Roasting is a process which causes a complex series of chemical changes in the beans wherein sugars and/or other organic compounds are pyrolized, and various volatiles are released so as to generate a complex pattern of flavor elements. In order to generate a good flavor profile, the roasting process must be very carefully controlled, both in terms of time and temperature. Under-roasted coffee produces a thin, latex-flavored, bitter beverage, while over-roasted coffee is oily and burnt tasting. Prolonged roasting, even at an appropriate temperature, volatilizes many of the flavor elements and produces a beverage of little taste. Roasting is further complicated by the fact that some of the reactions occurring during the roasting are exothermic, and as a consequence, the beans can readily become overheated even after being removed from a heat source. It will therefore be appreciated that roasting is a very complicated process, typically carried out by trained personnel.

A traditional roasting technique comprises tumbling the coffee beans in a heated drum. While the hardware for the process is relatively simple, control is difficult, and it is very easy to scorch, and ruin the beans. Furthermore, smoke and oils generated in the process remain in contact with the beans and can confer a disagreeable taste. As a consequence, the industry is turning to the use of fluidized bed roasters. In systems of this type, the coffee beans are at least partially levitated by a stream of heated air, and the degree of roasting is controlled by controlling the temperature of the air and the duration of the heating cycle. While fluidized bed roasters eliminate problems of contamination by smoke and oils, care must still be taken to avoid scorching the beans. Toward this end, prior art fluidized bed roasting systems typically include some provision for quenching the beans after they are roasted, as for example by an introduction of a stream of cool air or by spraying the beans with water. U.S. Pat. No. 4,484,064 discloses a fluidized bed coffee roaster in which ambient air is used for cooling. A somewhat similar system is disclosed in U.S. Pat. No. 5,185,171. U.S. Pat. Nos. 3,964,175 and 5,394623 both disclose the use of a water spray to cool the beans.

In all instances, the fluidized bed coffee roasters of the prior art carry out the quenching of the roasted beans in a single stage cycle carried out the roasting chamber itself. While such in-chamber, single stage quenching does produce an initial relatively quick drop in the temperature of the roasted beans, the present invention recognizes that residual heat in the roasting chamber, air delivery system and other relatively massive components of the fluidized bed apparatus can slow the further cooling of the beans, and thereby compromise the flavor profile of the roasted coffee. As will be explained in greater detail hereinbelow, the present invention provides a fluidized bed coffee roasting system and method which implements a two stage quenching cycle, wherein the roasted beans are first partially cooled in the roasting chamber during a first stage of the cycle, and then discharged to a fluidized bed quenching system, which is separate from the roasting chamber, and in which they are rapidly cooled to an ambient temperature in a second stage of the cycle. These and other features and advantages of the present invention will be apparent from the drawings, description and discussion which follow.

### BRIEF DESCRIPTION OF THE INVENTION

Disclosed is a fluidized bed coffee roaster having a two-stage cooling cycle. The roaster includes a roasting chamber having an air permeable member supported therein so as to be selectably displaceable from a first position in which it supports a volume of coffee beans thereupon to a second position in which it does not support the volume of coffee beans. The chamber includes air inlet disposed so as to direct a stream of air through the air-permeable member, when the air-permeable member is in its first position and has a volume of coffee beans supported thereupon, so as to flow through and fluidize said volume of coffee beans. The chamber further includes an air outlet disposed so as to direct the stream of air out of the chamber after it has passed through the volume of coffee beans, and a discharge outlet which is operable to discharge the volume of coffee beans from the roasting chamber when the air-permeable member is in its second position. The roaster further includes a blower operable to provide the stream of air and an air duct which conveys that stream of air from the blower to the inlet of the chamber. The roaster includes a heater disposed in association with the air duct at a point downstream of the blower and upstream of the roasting chamber. The heater is operable, when activated, to heat the stream of air.

The roaster includes a controller which is in operative communication with the blower, and the heater. The controller is operable to deactivate the heater while maintaining the operation of the blower and thereby initiate a first stage in a quenching cycle wherein the blower passes unheated air through the volume of coffee beans disposed in the roasting chamber.

The roaster further includes a fluidized bed quenching station comprising a container configured and operable to receive and retain the volume of coffee beans discharged from the outlet. The container has a bottom surface which is air-permeable. The fluidized bed quenching station further includes a quenchant air supply system disposed and operative, when activated, to deliver a stream of quenchant air through the bottom surface of the container, so as to fluidize and cool the volume of coffee beans in a second stage of the cooling cycle.

In specific embodiments, the controller may also be in communication with the fluidized bed quenching station and may be operable so as to activate the quenchant air supply system. The quenchant air may be supplied to the fluidized bed quenching station by the blower associated with the roaster or by a dedicated blower. The roaster may also include a roast temperature sensor disposed and operable so as to sense the temperature of the stream of air after it has passed through the volume of coffee beans, and generate a roast control signal corresponding thereto, and this signal may be communicated to the controller to initiate the quenching cycle.

Further disclosed is a method for roasting coffee beans in a fluidized bed coffee roaster which method employs a two-stage quenching cycle in which a first stage is carried out within a roasting chamber of the fluidized bed roaster by flowing a stream of unheated air through the beans, and a second stage of the cycle carried out in a fluidized bed quenching station separate from the roasting chamber, wherein a second stream of unheated air is flowed through, and fluidizes the coffee beans so as to further cool them.

### BRIEF DESCRIPTION OF THE DRAWINGS

FIG. 1 is a schematic view of one embodiment of coffee bean roaster structured in accord with principles of the present invention;

FIGS. 2A and 2B are cross sectional views of a portion of the roaster of FIG. 1, showing the roasting chamber with a perforated plate in two different positions;

FIG. 3 is a graph depicting one particular roast temperature profile employed in the present invention;

FIG. 4 Is a graph comparing the cooling rate of coffee beans quenched in a two stage cycle of the present invention with that of coffee beans quenched in a one stage cycle of the prior art;

FIG. 5 is a partially cut-away drawing of a fluidized bed quenching station of the present invention; and

FIG. 6 is a block diagram of one embodiment of control system in accord with the present invention.

### DETAILED DESCRIPTION OF THE INVENTION

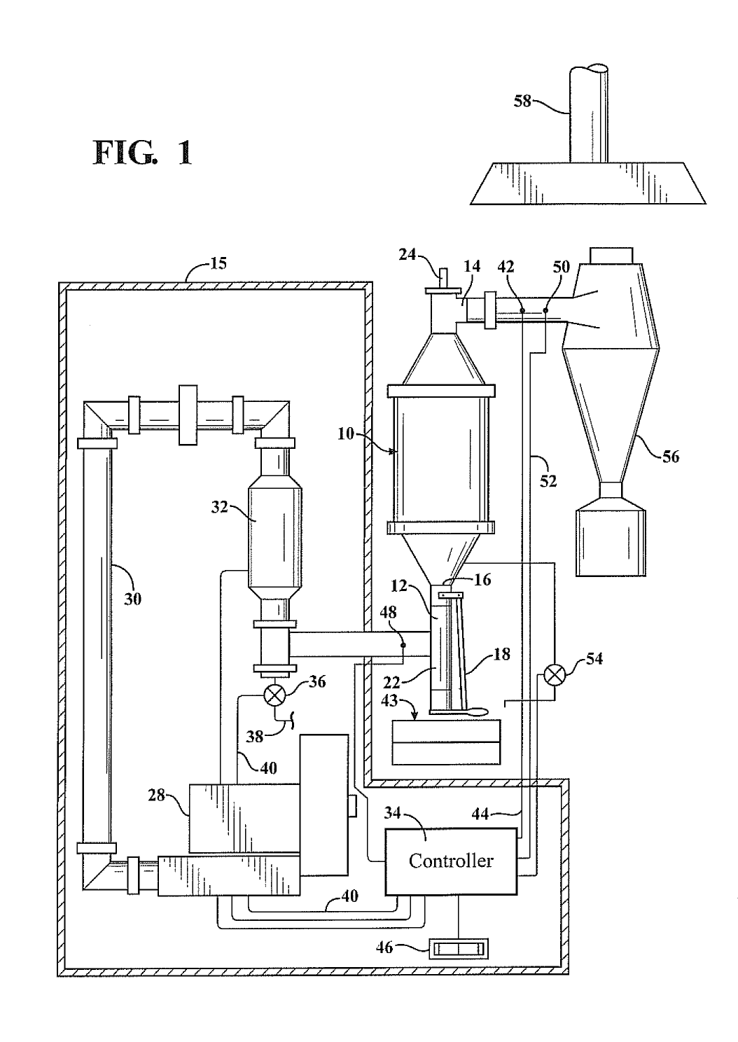

The present invention is directed to a fluidized bed roaster for coffee beans and the like, which cools the roasted beans to an ambient temperature in a two stage quenching cycle. The present invention may be implemented in a number of different embodiments including fully automated, fluidized bed roasting systems as well as in roasting systems which are under at least partial manual control. One specific system incorporating the present invention will be described with regard to FIG. 1, and it will be understood that the present invention may be otherwise embodied.

Referring now to FIG. 1, there is shown a schematic depiction of a generalized fluidized bed coffee roaster structured in accord with the principles of the present invention. The roaster includes a roasting chamber 10 which retains the coffee beans during the roasting process. The roasting chamber 10 includes an inlet 12 for introducing a stream of air into the chamber and an outlet 14 for permitting the stream to exit. The chamber also includes a perforated plate or screen which is permeable to the airstream and which supports a volume of coffee beans thereupon.

The perforated plate 16 is hingedly connected to a lever 18 which is further connected to a bottom closure member 20 which seals a bottom outlet 22 of the roasting chamber 10. It will also be noted that the chamber 10 includes a fill cap 24 which closes the top end thereof. In a specific embodiment, at least the central, cylindrical portion 26 of the roasting chamber 10 is fabricated from a transparent material, preferably borosilicate glass or a high temperature polymer, so as to permit viewing of the beans while they roast.

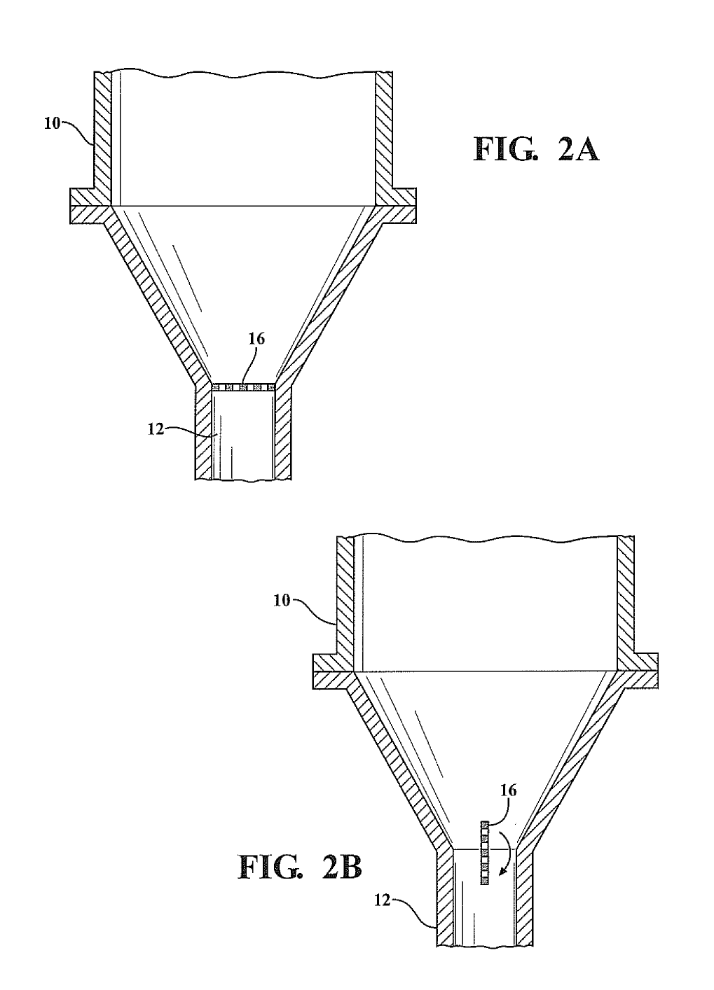

Referring now to FIGS. 2 A and 2 B, there is shown a cross section of a portion of the apparatus of FIG. 1 showing the roasting chamber 10, perforated plate 16 and inlet 12. In FIG. 2A, the perforated plate 16 is in a first position, in which it seals the bottom of the roasting chamber and retains a volume of coffee beans therein. FIG. 2B shows the plate 16 in a second position in which it permits discharge of the beans from the chamber. Movement of the plate 16 between the first and second positions may be accomplished manually, as for example by lever 18, or automatically as for example by an electromechanical actuator (not shown).

The system of FIG. 1 includes an air conduit 30, which communicates with the inlet 12 of the chamber 10. The conduit 30 is also in communication with a blower 28 and serves to direct a flow of air from the blower 28 into and through the chamber 10. Interposed downstream of the blower 28 and upstream of the chamber 10 is a heater 32 which heats the air passing through the conduit. The heater 32 is operatively connected to a controller 34 which selectively activates the heater 32 so as to provide a controlled temperature profile to the heated air provided to the roasting chamber 10.

The system of FIG. 1 optionally includes a water injection solenoid valve 36, operatively connected via a supply line 38 to a source of water, such as a water main, not shown. This water injection solenoid valve 36 is in electrical communication with the controller via a control line 40. It is to be understood that other embodiments may not include a water injection system.

The controller 34 may also be in electrical communication with a roast temperature sensor 42 which is disposed proximate the outlet 14 of the roast chamber 10. The roast temperature sensor 42 measures the temperature of the air which has passed through the volume of coffee beans and provides a control signal which is sensed by the controller 34 via control line 44.

In the operation of the FIG. 1 system a charge of coffee beans is placed into the roasting chamber 10 through the fill cap 24. The system is activated via a master switch 46 in communication with the controller 34. The controller activates the blower 28 so as to provide a stream of air which is directed through the conduit 30 to the roasting chamber 10. Once the air is flowing, the controller activates the heater (via an in line pressure switch) 32 so as to begin providing heated air to the chamber 10. As noted hereinabove, it is desirable that the heater be operated so as to control the time-temperature profile of the air. It has been found that if intense heat is applied to the beans too suddenly, the exterior of the beans may be over heated and burnt before sufficient temperature has been conducted to roast the interior of the beans, hence it is generally desirable that the controller activate the heater so as to provide a profiled application of heat. Activation may be in accord with a preset sequence resident in the controller or it may be further accomplished through the use of an air temperature sensor 48 which is in communication with the controller and which is disposed in the conduit 30 at a point downstream of the heater 32 and upstream of the roasting chamber 10.

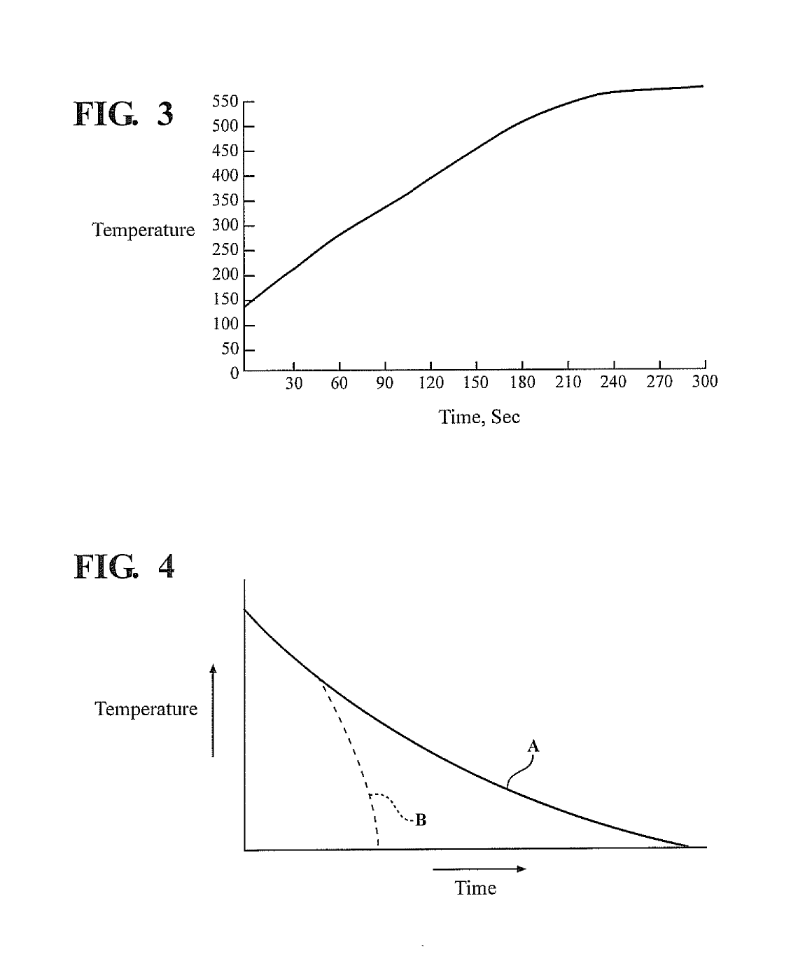

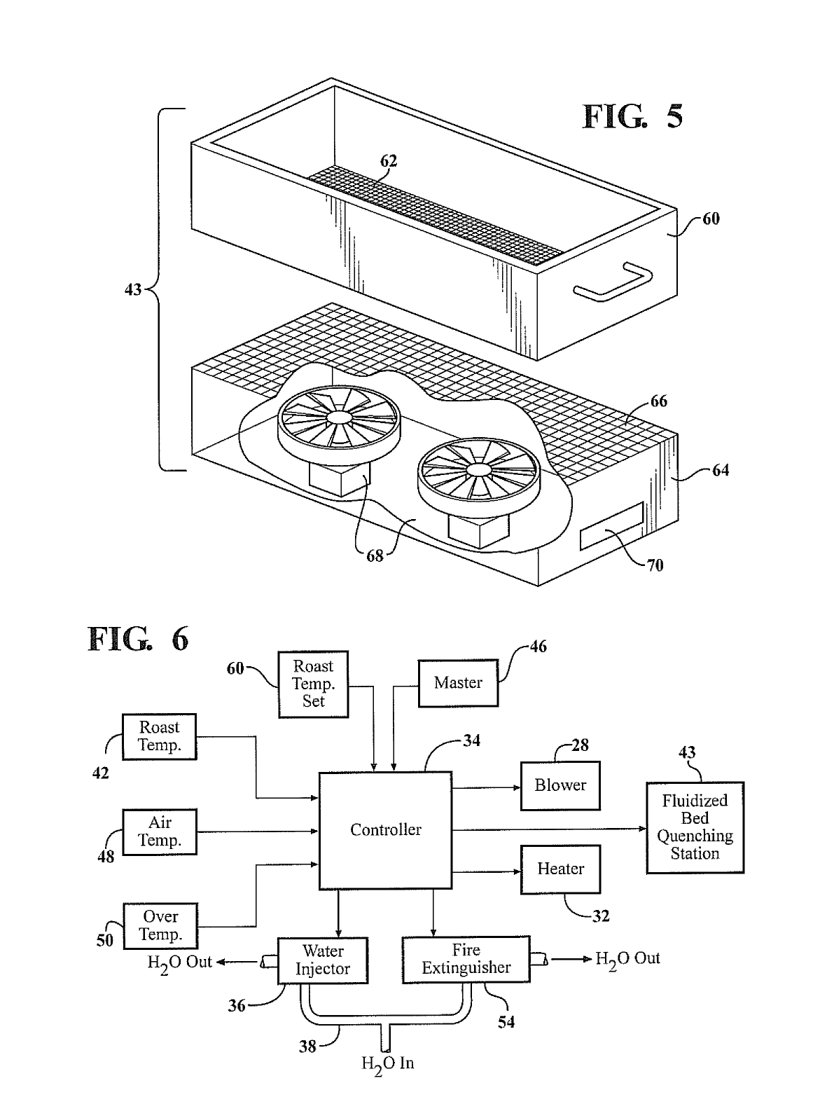

Referring now to FIG. 3, there is shown one time temperature profile which has been found to have utility in the present invention. The graph shows air temperature in the conduit, at a point corresponding to the temperature sensor 48 of FIG. 1 and depicts this temperature as a function of cycle time. It will be noted that the air is initially at an ambient temperature of approximately 70 degrees F. The air temperature at first rises at a fairly rapid rate for approximately three minutes to approximately 400.degrees F. During the next four minutes, the temperature rises much more gradually (via a predetermined profile) from 400 degrees F. to approximately 540 degrees F. It has been found that a profiled rise of this general type precludes exterior charring of the beans. It is to be understood that depending upon air flow, dimensions of the roasting chamber and other such parameters, other profiles may be found advantageous.

In the operational cycle, the heated air flows through the inlet 12 and the perforated plate 16 and at least partially levitates the coffee beans into a fluidized bed. The temperature of the air exiting the chamber is measured by a roast sensor 42 and when a preselected temperature is reached, roasting cycle is considered completed. The specific temperature will depend upon the weight of beans being roasted, the darkness of the roast desired as well as the particular parameters of the specific roasting system such as air inlet temperature, heater capacity, system size and the like. In one particular system it has been found that with an air inlet temperature of 540 degrees F., profiled as described hereinabove, a medium roast of a one to two pound charge of coffee is complete when a roast temperature sensor measures a temperature of approximately 385-445 degrees F. at the outlet.

The controller 34 is in communication with the roast temperature sensor 42, and when a preselected roast temperature is achieved, the controller deactivates the heater 32 and initiates the first stage of the two stage quenching cycle of the present invention. The blower 28 is maintained in operation during this first stage, and air provided therefrom is considered “unheated” in the context of this disclosure, even though it may still be at a temperature warmer than ambient owing to residual heat in the system. Water may optionally be injected into the unheated air stream through the solenoid valve 36. The injected water quickly turns to steam, and in so doing cools the air stream and the conduit 30. The unheated air passes through the beans in the roast chamber and exits through the outlet 14 thereof.

As discussed above, in prior art systems, all cooling takes place in the chamber in a single stage process; however, residual heat in the heater, the conduits, and the roasting chamber slows the continued cooling of the roasted beans, and the present invention recognizes that this delayed cooling will interfere with the achievement of a maximum flavor profile in the roasted coffee. Referring now to FIG. 4, there is shown a graph of time versus temperature with regard to the cooling of a volume of coffee beans from a roast temperature to a fully-quenched, ambient room temperature. Curve A shows a cooling profile typical of a single stage prior art quenching cycle. As will be seen, the beans initially cool at a fairly quick rate; but, the rate of heat loss decreases giving the cooling profile a long “tail.” Curve B shows the cooling profile achieved with the two stage quenching process of the present invention. In the first stage, which is carried out in the chamber, the rate of cooling is identical to that of the single stage process of the prior art; however, before the rate of cooling slows appreciably, the beans are removed from the chamber and cooled in a separate fluidized quenching bed. As will be seen the beans reach ambient temperature very quickly avoiding the development of undesirable flavor profiles.

Following completion of the first stage of the quenching cycle, the air-permeable plate is rotated to its second position allowing the roasted (and still hot) beans to exit the chamber 10 through the outlet 22 which directs them to a fluidized bed quenching station 43 in which they are rapidly cooled to ambient temperature in the second stage of the quenching cycle.

Referring now to FIG. 6, there is shown an exploded, partially cut-away view of an embodiment of a fluidized bed quenching station employed for the second stage of the quenching cycle. The station 43 includes a container 60 which is configured to receive discharged coffee beans from the outlet 22 of the roaster. The container 60 includes a bottom surface 62 which is air-permeable. This surface may comprise a screen or a mesh, a perforated body of solid material, or the like. The fluidized bed quenching station also includes a base 64 which is configured to support the container 60 thereupon. The base 64 includes an air-permeable upper surface 66 which, like the bottom surface of the container 62, may comprise a mesh or perforated body. The base 64, in this embodiment, includes a blower 68 therein which is operative to discharge a relatively high volume flow of air through the upper surface 66 of the base 64. In a typical implementation, the base will also include one or more openings, such as opening 70, to accommodate the inward flow of air to the blower 68. In alternative embodiments, the base 68 may not include a separate blower; but, may rely upon the blower 28, with appropriate conduits, to provide a stream of fluidizing air.

In the operation of the fluidized bed quenching station, the container 60 having the coffee beans disposed therein it will be supported on the base 64 which operates to direct a volume of unheated, cooling, air through the air-permeable bottom surface 62 of the container 60 so as to at least partially levitate and fluidize the coffee beans. Given the fact that the components of the fluidized bed quenching station 43 will be at an approximately ambient temperature during this stage of the quenching cycle, and given the fact that the beans will be fluidized in a volume of unheated air the roasted beans will cool very rapidly to ambient temperature thereby preserved in their flavor profile.

As further illustrated in FIG. 1, the basic system may include other refinements. For example, the system may include an over temperature sensor 50, shown here for example, in the outlet stream. The over temperature sensor functions to detect an emergency situation resultant from a fire in the roasting chamber or other such malfunction. The over temperature sensor 50 is in operative communication with the controller via a control line 52. Should an over temperature condition be detected, the controller 34 immediately deactivates the heater 32 and blower 28. The controller 34 may also activate the water injector 36 as well as a fire control water inlet 54 which floods the roasting chamber 10 thereby extinguishing any fire which may occur. As illustrated in FIG. 1, the system may include a cabinet 15, which houses the blower 28, controller 34, heater 32, and associated portions of the conduit 30.

Other ancillary equipment to the system may include a separator 56, such as a cyclonic separator which operates to collect the chaff generated during the roasting of coffee. The system may also include a vent hood 58 for exhausting heated air from the vicinity of the roaster.

As discussed above the two stage quenching cycle of the present invention may be implemented in a variety of fluidized bed roasting systems, including fully automated systems as well as systems which are under partial or fully manual control. Referring now to FIG. 6, there is shown a block diagram of a typical automated system such as that of FIG. 1. Shown is a controller 34 which is disposed to receive signals from a roast temperature sensor 42, an air temperature sensor 48 and an over temperature sensor 50. The controller also is in communication with a master switch 46 for activation of the system as well as a roast temperature set switch 60. The roast temperature set switch programs a preselected roast temperature into the controller so that the controller may activate the two stage quenching cycle, as noted above, when the preselected roast temperature is measured by the roast temperature sensor 42. In that regard, the controller 34 is also in communication with the heater 32, blower 28, water injector 36 (when included) and the air supply portion of the fluidized bed quenching station 43.

In some embodiments, the roast temperature set switch 60 is dispensed with, and an optimized roast temperature is preprogrammed into the controller; but for other applications, it may be desirable to specify a particular roast temperature. As noted above, in this manner the degree of roasting may be controlled to provide a light, medium or dark roast. Also, in some instances large volumes of beans will require somewhat lower final roast temperature as compared to a smaller volume of beans, to achieve an equivalent roast, because of higher back pressure in the roast chamber. It is to be understood that the controller 34 may comprise a single microprocessor based unit, or the controller may be a distributed control system comprised of a number of units which separately monitors and responds to various parameters such as the roast temperature, heater profile and over temperature condition. All of these variations are within the scope of the present invention.

In view of the foregoing, it will be appreciated that the invention may be practiced in a variety of configurations. The principles hereof may be adapted to very large volume roasters as well as relatively small systems for consumer use or point of purchase roasting. One particularly preferred system adapted for point of purchase roasting is operative to roast between 0.5 and 5 pounds of coffee at a time. The system includes a glass tube based roasting chamber. A particularly preferred heater comprises a high wattage, low volume heater which is configured to surround a portion of the air conduit. Heaters of this type are efficient and have a relatively small thermal mass, and hence provide for rapid heating and cooling. One preferred heater is sold by the Osram-Sylvania Corporation, and it has been found that the 10,000 watt, 208 volt, one phase model provides good performance in the afore-described system. This heater is preferably controlled via an SCR power controller. Such controllers are staple items of commerce and are available, for example, from the Whatlow Electric Manufacturing Co. There are a variety of blowers which may be employed in the present invention. One preferred blower for use in the roasting portion of the system is that sold by Gast Manufacturing under the designation R4110-2; another which may be used is available from Ametek Industrial Products under the designation Model 11901-01. The quenching station will typically incorporate a smaller blower, and one particular blower having utility in this invention available from the Dayton Electric Company. The temperature sensors are preferably thermocouples or thermistors, as is well known in the art. As noted above, the controller may comprise a single microprocessor based controller, or it may a distributed system. There are available in the market, a number of systems for controlling heaters, blowers and other heavy loads in response to thermocouple or thermistor input. One source of such controllers is the Watlow Corporation of Winona, Minn.

It will be appreciated from the foregoing, that the system of the present invention will be implemented in a variety of configurations. And while the invention has been described with particular regard to a coffee roaster, it is to be understood that the present invention may be practiced in conjunction with other types of food product roasters such as nut roasters. Therefore, it is to be understood that the foregoing drawings, discussion and description are merely meant to illustrate particular embodiments of the invention, and are not meant to be limitations upon the practice thereof. It is the following claims, including all equivalents, which define the scope of the invention.

1. A fluidized bed coffee roaster providing a two stage cooling cycle, said roaster comprising:
a roasting chamber including an air-permeable member which is supported in said chamber so as to be selectably displaceable from a first position in which it supports a volume of coffee beans thereupon, to a second position in which it does not support the volume of coffee beans; an air inlet disposed so as to introduce a stream of air into said chamber, through said air-permeable member when said air-permeable member is in said first position, so as to pass through and fluidize said volume of coffee beans; an air outlet disposed so as to direct said stream of air out of the chamber after it has passed through the volume of coffee beans; and, a discharge outlet which is operable to discharge the volume of coffee beans from said roasting chamber when said air-permeable member is in said second position:
a blower operable to provide said stream of air;
an air duct operatively connecting said blower with the air inlet of the chamber so as to direct the stream of air from the blower to the inlet;
a heater associated with the air duct at a point downstream of the blower and upstream of the roasting chamber, said heater, when activated, being operable to heat the stream of air;
a roast temperature sensor disposed and operable so as to sense the temperature of the stream of air after it has passed through the volume of coffee beans, and generate a roast control signal corresponding thereto;
a controller which is in operative communication with the roast temperature sensor, the blower, and the heater, said controller being operable to deactivate the heater, while maintaining the operation of the blower when it receives a roast control signal indicative of a preselected air stream temperature, so as to initiate a first stage in a cooling cycle wherein said blower passes unheated air through the volume of coffee beans disposed in said roasting chamber; and
a fluidized bed quenching station comprising: a container configured and operable to receive and retain the volume of coffee beans from said discharge outlet, said container having a bottom surface which is air-permeable; and a quenchant air supply system disposed and operative, when activated, to deliver a stream of quenchant air through the bottom surface of said container, so as to fluidize and cool said volume of coffee beans in a second stage of the cooling cycle.

2. The coffee roaster of claim 1, wherein said controller is in communication with said fluidized bed quenching station and is operable to activate said quenchant air supply system.

3. The coffee roaster of claim 2, wherein said controller is operable to activate said quenchant air supply system when said container has received the volume of coffee beans from said discharge outlet.

4. The coffee roaster of claim 1, wherein said blower is operable to deliver a stream of air to said quenchant air supply system.

5. The coffee roaster of claim 1, wherein said quenchant air supply system comprises a base configured to retain said container thereupon.

6. The coffee roaster of claim 5, wherein said base includes a dedicated quenchant air blower therein.

7. The coffee roaster of claim 1, wherein said air-permeable member is manually displaceable from one of said first position and said second position to the other of said first position and said second position.

8. The coffee roaster of claim 1, wherein said controller is further operable to displace said air-permeable member from one of said first position and said second position to the other of said first position and said second position.

9. The coffee roaster of claim 1, further including a water injector, operable when activated, to inject water into the air conduit at a point upstream of the roasting chamber so as to cool the stream of air before it passes through said volume of coffee beans.

10. The coffee roaster of claim 9, wherein said water injector is in communication with said controller, and said controller is operable to activate said water injector during at least a portion of the first stage of the cooling cycle.

11. The coffee roaster of claim 1, further including an air stream temperature sensor disposed in the conduit at a point upstream of the roasting chamber and downstream of the heater, said air stream temperature sensor being operable to provide a second control signal corresponding to the temperature of the stream of air upstream of the roasting chamber.

12. The coffee roaster of claim 11, wherein the controller is in operative communication with the air stream temperature sensor and wherein said controller is further operable to activate the heater in response to the second control signal.

13. A method for roasting coffee beans comprising the use of the coffee roaster of claim 1.

14. A method for roasting and quenching coffee beans comprising:
providing a fluidized bed coffee roaster having a roasting chamber configured to support a volume of coffee beans therein
introducing a volume of coffee beans into said roasting chamber;
introducing a stream of heated air into said chamber so as to fluidize and heat said volume of coffee beans;
maintaining the flow of said stream of heated air for a period of time sufficient to roast said volume of coffee beans;
terminating the flow of said stream of heated air, and thereafter introducing a first stream of cooling air, having a temperature which is less than the temperature of said stream of heated air, air into said chamber so as to fluidize and cool said volume of coffee beans in a first stage of a quenching process;
removing said volume of coffee beans from said roasting chamber before they have been cooled to an ambient temperature; and
directing a second stream of cooling air through said volume of coffee beans so as to cool said beans to an ambient temperature in a second stage of said quenching process.

15. A fluidized bed roaster providing a two stage cooling cycle, said roaster comprising:
a roasting chamber which is configured to support a volume of a food product therein; an air inlet disposed so as to introduce a stream of air into said chamber so as to pass through and fluidize said volume of food product; an air outlet disposed so as to direct said stream of air out of the chamber after it has passed through the volume of food product; and, a discharge outlet which is operable to discharge the volume of food product from said roasting chamber:
a blower operable to provide said stream of air;
an air duct operatively connecting said blower with the air inlet of the chamber so as to direct the stream of air from the blower to the inlet;
a heater associated with the air duct at a point downstream of the blower and upstream of the roasting chamber, said heater, when activated, being operable to heat the stream of air;
a control which is in operative communication with the roast temperature sensor, the blower, and the heater, said control being selectably operable to deactivate the heater, while maintaining the operation of the blower so as to initiate a first stage in a cooling cycle wherein said blower passes unheated air through the volume of food product disposed in said roasting chamber; and
a fluidized bed quenching station comprising: a container configured and operable to receive and retain the volume of food product from said discharge outlet, said container having a bottom surface which is air-permeable; and a quenchant air supply system disposed and operative, when activated, to deliver a stream of quenchant air through the bottom surface of said container, so as to fluidize and cool said volume of food product in a second stage of the cooling cycle.
